(19) United States
(12) Patent Application Publication
(10) Pub. No.: US 2024/0150048 A1
(43) Pub. Date: May 9, 2024

(54) DISTRIBUTED ARCHITECTURE OF MOVABLE PLATFORM AND MOVABLE PLATFORM

(71) Applicant: SZ DJI TECHNOLOGY CO., LTD., Shenzhen (CN)

(72) Inventor: Jun JING, Shenzhen (CN)

(73) Assignee: SZ DJI TECHNOLOGY CO., LTD., Shenzhen (CN)

(21) Appl. No.: 18/415,943

(22) Filed: Jan. 18, 2024

Related U.S. Application Data
(63) Continuation of application No. PCT/CN2021/107683, filed on Jul. 21, 2021.

(51) Int. Cl. B64U 20/83; B64U 10/13; B64U 20/87

(52) U.S. Cl. CPC B64U 20/83; B64U 10/13; B64U 20/87; B64U 2201/00

(57) ABSTRACT

A distributed structure of a movable platform and a movable platform are provided. The movable platform includes: a platform body, a driving part, a plurality of signal modules divided into at least two groups, where each group of the signal modules is concentrated in one area; at least two control modules, where each control module is arranged in the area where a corresponding group of the signal modules is located, and each control module can directly obtain signals of the corresponding group of the signal modules in its area; and an signal transmission device, which is provided between the control modules and is configured to transmit signals between the control modules.

### RELATED APPLICATIONS

This application is a continuation application of PCT application No. PCT/CN2021/107683, filed on Jul. 21, 2021, and the content of which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the technical field of movable platforms, and in particular to a distributed architecture (structure) of a movable platform and a movable platform.

### BACKGROUND

At present, unmanned aerial vehicle (UAV) control systems generally adopt centralized control. Traditional centralized control requires that all sensors and loads (such as cameras, radars, electronic speed controls, perception sensors, gimbals, etc.) be centrally connected to a core board for processing.

With the development of UAV products, UAVs require more and more sensors and loads, and the signal bandwidths thereof are getting higher and higher. In such a case, traditional centralized control brings several problems to UAV product design: first, for large-size UAVs, all sensors and loads are connected to the core board, which may cause the signal wires to be too long. Long-distance transmission of high-speed signals may cause signal distortion, bit errors, and even disconnection, reducing the overall reliability of the UAVs; second, the longer the high-speed signal wires, the stronger the signal radiation and the more serious the interference, which reduces the performance of the UAVs.

### SUMMARY

In light of the foregoing, the present disclosure provides a distributed architecture (structure) of a movable platform and a movable platform.

In one aspect, the present disclosure provides a movable platform, including: a platform body; a driving part to drive the movable platform to move; a plurality of signal modules, divided into at least two groups, with each group of signal modules concentrated in an area; at least two control modules, with each control module arranged in a corresponding area where a corresponding group of signal modules is located, where each control module is configured to obtain corresponding signals from the corresponding group of signal modules in the corresponding area respectively; and a signal transmission device, arranged between the at least two control modules and configured to transmit signals between the at least two control modules.

In another aspect, the present disclosure provides a control method, including: issuing, by at least two control modules taking turns in a cyclic manner, a control instruction based on signals from a plurality of signal module at predetermined time intervals, where each control module is configured to obtain the signals from the plurality of signal modules; transmitting signals between the at least two control modules via a signal transmission device; and controlling, based on the control instruction, at least one of the movable platform, or the plurality of signal modules.

Some exemplary embodiments of the present disclosure provide a distributed architecture (structure) of a movable platform and a movable platform. The distributed structure includes: a plurality of signal modules, which can be divided into at least two groups, with each group of the signal modules being concentrated in one area; at least two control modules, where each of the control modules is arranged in an area where a corresponding group of the signal modules is located, each control module can directly obtain the signals of the group of the signal modules in the area thereof; and a signal transmission device provided between the control modules and is configured to transmit signals between the control modules. Compared with centralized control in existing technologies, which requires all sensors and loads to be centrally connected to a core board, according to some exemplary embodiments of the present disclosure, the plurality of signal modules can be divided into a plurality of groups and distributed in a plurality of different areas. Each group of signal modules is concentrated in one area; not all signal modules are connected to one control module; rather a plurality of control modules are provided correspondingly. Each control module is arranged in the area where a corresponding group of signal modules is located, and can directly obtain the signals of this group of signal modules in the area. In this way, the present disclosure can make the signal modules to be connected to the control module in an area nearby, avoiding the problems of signal distortion, bit errors or disconnection caused in the case where all of them are connected to the same control module and the signal wiring is too long. In addition, due to the nearby connection mentioned above, the signal wiring can be short, which can minimize signal radiation and signal interference, and improve the performance of the movable platform. Moreover, the signal transmission device is arranged between control modules and can be configured to transmit signals between control modules. Optical fiber has fast transmission speed, wide transmission frequency, high communication capacity, low loss, and strong anti-radiation and anti-interference capabilities. This ensures the sharing and transmission of the overall signals of the movable platform accurately and quickly.

It should be understood that the above general description and the following detailed description are only exemplary and explanatory, and do not limit the present disclosure.

### BRIEF DESCRIPTION OF THE DRAWINGS

In order to more clearly illustrate the technical solutions of the embodiments of the present disclosure, the following will briefly introduce the drawings for the description of some exemplary embodiments. Apparently, the accompanying drawings in the following description are some exemplary embodiments of the present disclosure. For a person of ordinary skill in the art, other drawings may also be obtained based on these drawings without creative efforts.

FIG. 1 is a schematic structural diagram of some exemplary embodiments of the centralized control of a UAV in the existing technologies;

FIG. 2 is a schematic structural diagram of a distributed structure of a movable platform according to some exemplary embodiments of the present disclosure;

FIG. 3 is a schematic structural diagram of a distributed structure of a movable platform according to some exemplary embodiments of the present disclosure;

FIG. 4 is a schematic structural diagram of a distributed structure of a movable platform according to some exemplary embodiments of the present disclosure;

FIG. 5 is a schematic structural diagram of a distributed structure of a movable platform according to some exemplary embodiments of the present disclosure; and

FIG. 6 is a schematic structural diagram of a distributed structure of a movable platform according to some exemplary embodiments of the present disclosure.

Description of main components of the symbols thereof:
100, Distributed structure;
10, Signal module; 20, Control module; 21, Data receiving and forwarding unit; 22, Interface; 23, Calculation and processing unit; 30, Optical fiber bus; 31, Optical fiber; 32, Emitting part; 32A, First emitting part; 32A1, First driver; 32A2, First vertical-cavity surface-emitting laser; 32A3, First lens; 32B, Second emitting part; 3261, Second driver; 3262, Second vertical-cavity surface-emitting laser; 33, Receiving part; 33A, First receiving part; 33A1, Second lens; 33A2, First photon detector; 33A3, First trans-impedance amplifier; 33B, Second receiving part; 3362, Second photon detector; 3363, Second trans-impedance amplifier.

### DETAILED DESCRIPTION

The technical solutions in some exemplary embodiments of the present disclosure will be described below with reference to the accompanying drawings in the embodiments of the present disclosure. Obviously, the described embodiments are part of the embodiments of the present disclosure, but not all of the embodiments. Based on the exemplary embodiments in the present disclosure, all other embodiments obtained by a person of ordinary skill in the art without creative efforts fall within the scope of protection of the present disclosure.

The flowcharts shown in the accompanying drawings are only examples and do not necessarily include all contents and operations/steps, nor are they necessarily performed in the order described. For example, some operations/steps may also be separated, combined or partially combined. Therefore, the actual execution order may be altered based on actual conditions.

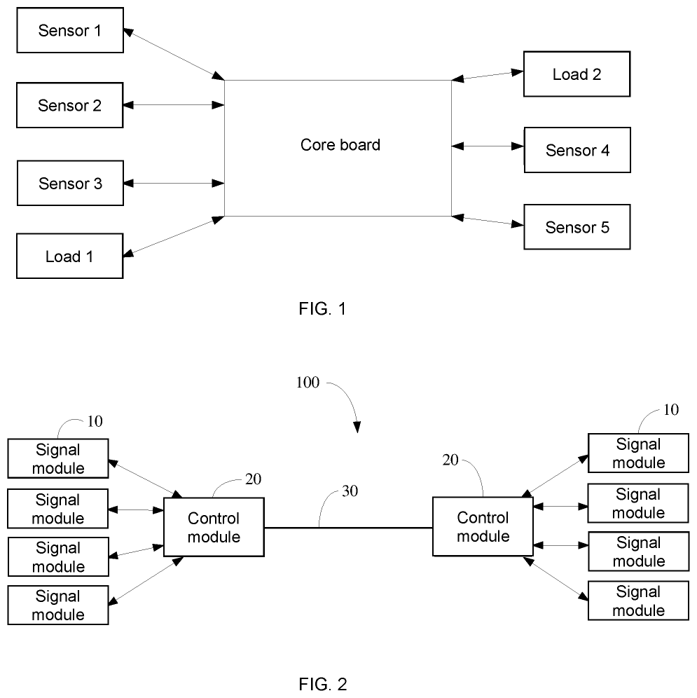

At present, UAV control systems generally adopt centralized control. Traditional centralized control requires all sensors and loads to be centrally connected to the core board for processing, as shown in FIG. 1. As UAVs require more and more sensors and payloads, the signal bandwidth is getting higher and higher. In such as case, traditional centralized control brings several problems to UAV product design: first, it can cause the signal wiring to be too long, which can lead to signal distortion, bit errors, and even disconnection, reducing the overall reliability of the UAVs; second, the signal radiation is high and the interference is serious, which may reduce the performance of the UAVs.

Some exemplary embodiments of the present disclosure provide a distributed structure of a movable platform and a movable platform. The distributed structure includes: a plurality of signal modules, which can be divided into at least two groups, with each group of the signal modules being concentrated in one area; at least two control modules, where each of the control modules is arranged in an area where a corresponding group of the signal modules is located, each control module can directly obtain the signals of the group of the signal modules in the area thereof; and a signal transmission device (the signal transmission device herein may be any suitable type of signal transmission device; for the purpose of illustration, an optical fiber bus will be used as an example in the following description) provided between the control modules and is configured to transmit signals between the control modules. Compared with centralized control in existing technologies, which requires all sensors and loads to be centrally connected to a core board, according to some exemplary embodiments of the present disclosure, the plurality of signal modules can be divided into a plurality of groups and distributed in a plurality of different areas. Each group of signal modules is concentrated in one area; not all signal modules are connected to one control module; rather a plurality of control modules are provided correspondingly. Each control module is arranged in the area where a corresponding group of signal modules is located, and can directly obtain the signals of this group of signal modules in the area. In this way, the present disclosure can make the signal modules to be connected to the control module in an area nearby, avoiding the problems of signal distortion, bit errors or disconnection caused in the case where all of them are connected to the same control module and the signal wiring is too long. In addition, due to the nearby connection mentioned above, the signal wiring can be short, which can minimize signal radiation and signal interference, and improve the performance of the movable platform. Moreover, the optical fiber bus is arranged between control modules and can be configured to transmit signals between control modules. Optical fiber has fast transmission speed, wide transmission frequency, high communication capacity, low loss, and strong anti-radiation and anti-interference capabilities. This ensures the sharing and transmission of the overall signals of the movable platform accurately and quickly.

Some exemplary embodiments of the present disclosure will be described in detail below with reference to the accompanying drawings. The following exemplary embodiments and features in these embodiments may be combined with each other without conflict.

With reference to FIG. 2. FIG. 2 is a schematic structural diagram of a distributed structure of a movable platform according to some exemplary embodiments of the present disclosure. The distributed structure herein can be applied to a movable platform; the movable platform may refer to various types of platforms that can move automatically or under certain controlled conditions, for example: UAVs, vehicles, unmanned vehicles, ground robots, unmanned ships, etc. In some exemplary embodiments, the mobile platform includes a UAV.

The distributed structure 100 can include: a plurality of signal modules 10 (the number of the signal modules in the figure is eight, for example only), at least two control modules 20 (the number of the control modules in the figure is two, for example only), and a fiber optic bus 30.

The plurality of signal modules 10 can be divided into at least two groups, and the signal modules 10 in each group are concentrated/arranged in one area. Each control module 20 is arranged in an area where a corresponding group of signal modules 10 is located. Each of the control modules 20 can directly obtain the signals of the corresponding group of the signal modules 10 in the area where it is located. The optical fiber bus 30 is provided between the control modules 20 and is used for transmitting signals between the control modules 20.

In some exemplary embodiments, the signal modules 10 may refer to electronic hardware that can provide signals. The signal modules 10 include, but are not limited to, sensors and/or loads. The sensors herein may include, but are not limited to: perception sensors, camera sensors, radar, GPS sensors, time-of-flight sensors, inertial sensors, accelerometers, gyroscopes, magnetic compasses, ultrasonic sensors, barometers, etc.; the loads herein may include, but are not limited to: gimbals, compasses, electronic speed controls, etc. In some exemplary embodiments, the signal module(s) 10 may include two or more types of sensing sensors, camera sensors, gimbals, radars, global positioning system sensors, time-of-flight sensors, inertial sensors, compasses, and electronic speed controls, etc.

The optical fiber bus 30 has the dual advantages of channel and network. It has the advantages of high bandwidth, high reliability, high stability, resistance to electromagnetic interference, etc. It can provide a very stable and reliable optical fiber connection, making it easy to build large-scale data transmission and communication networks. The principle of optical fiber communication is as follows: at a transmitting end, a transmitted signal (such as voice) is first converted into an electrical signal, which is then modulated to a laser beam emitted by a laser device, so that the intensity of the light changes with the amplitude (frequency) of the electrical signal, which is sent out through an optical fiber; at a receiving end, a detector receives the optical signal and converts it into an electrical signal, after demodulation, the original signal is recovered.

In some exemplary embodiments, the plurality of signal modules 10 can be divided into at least two groups, and the signal modules 10 in each group are concentrated in one area. Each group of signal modules 10 may include the same signal modules 10 or different signal modules 10.

For example, the plurality of signal modules may include A, B, C, D, E, F, G, H, I, J, K, and L. which are divided into three groups. The first group includes A, B, C, and D; the second group includes E, F, G, and H; and the third group includes I, J, K, and L. The signal modules in these three groups are not the same. In another example, the plurality of signal modules may include three As, three Bs, three Cs, and three Ds, which are divided into three groups, and each group includes A, B, C, and D. In yet another example, the plurality of signal modules may include three As, three Bs, C, D, E, F, G, and H, which are divided into three groups. The first group includes A, B, C, and D; the second group includes A, B, E, and F; and the third group includes A, B, G, and H.

The number of signal modules 10 in each group may be the same or different. For example, there are two groups of signal modules. The number of signal modules in one group is 4, and the number of signal modules in the other group of is also 4. In another example, there are two groups of signal modules, the number of signal modules in one group is 4, and the number of signal modules in the other group is 3.

In some exemplary embodiments, the number of control modules 20 is the same as the number of signal module 10 groups. Each group of signal modules 10 is concentrated in one area. Each area is provided with a control module 20. The control module 20 of each area is connected to the signal modules 10 of the group in the area. The control module 20 can directly obtain the signals of the group of signal modules 10 in the area where it is located (that is, the signal modules 10 directly transmit signals to the control module 20 without passing through the optical fiber bus 30). The control modules 20 are connected by the optical fiber bus 30. The optical fiber bus 30 is used to transmit signals between the control modules 20. The control module 20 can issue control instructions, based on the signals of the signal modules 10, to control a movable platform and/or the signal modules.

It should be noted that after receiving a signal from the signal module 10, the control module 20 can forward the received signal from the signal module 10 to other control modules 20 via the optical fiber bus 30. The control module 20 can indirectly obtain signals of the signal module 10 in other areas (that is, areas other than the area where the control module 10 is located). That is, each control module 20 can indirectly obtain the signals of a group of signal modules 10 in the area where other control modules 20 are located via the optical fiber bus 30. After receiving the signal from the signal module 10, the control module 20 may also process the received signal from the signal module 10, and then forward the processed signal to other control modules 20 via the optical fiber bus 30.

Therefore, a signal transmitted between the control modules 20 may be a signal of the signal module 10 in the area received by the control module 20 that has not been processed by the control module 20, a signal of the signal module 10 in the area received by the control module 20 and processed by the control module 20, or other signals (for example, a signal indicating an abnormality of the control module 20, a signal indicating a fault of the control module 10, etc.). In order to simplify the circuit structure, a signal transmitted between the control modules 20 is usually the signal of the signal module 10 received by the control module 20 in the area where it is located and has not been processed by the control module 20.

In some exemplary embodiments, the distributed structure 100 includes: a plurality of signal modules 10, which can be divided into at least two groups, with each group of the signal modules 10 being concentrated in one area; at least two control modules 20, where each of the control modules 20 is arranged in an area where a corresponding group of the signal modules is located, each control module 20 can directly obtain the signals of the group of the signal modules 10 in the area thereof; and an optical fiber bus 30 provided between the control modules 20, and is configured to transmit signals between the control modules 20. Compared with centralized control in existing technologies, which requires all sensors and loads to be centrally connected to a core board, according to some exemplary embodiments of the present disclosure, the plurality of signal modules 10 can be divided into a plurality of groups and distributed in a plurality of different areas. Each group of signal modules 10 is concentrated in one area; not all signal modules 10 are connected to one control module 20; rather a plurality of control modules 20 are provided correspondingly. Each control module 20 is arranged in the area where a corresponding group of signal modules 10 is located, and can directly obtain the signals of this group of signal modules 10 in the area. In this way, the present disclosure can make the signal modules 10 to be connected to the control module 20 in an area nearby, avoiding the problems of signal distortion, bit errors or disconnection caused in the case where all of them are connected to the same control module 20 and the signal wiring is too long. In addition, due to the nearby connection mentioned above, the signal wiring can be short, which can minimize signal radiation and signal interference, and improve the performance of the movable platform. Moreover, the optical fiber bus 30 is arranged between control modules 20 and can be configured to transmit signals 20 between control modules. Optical fiber has fast transmission speed, wide transmission frequency, high communication capacity, low loss, and strong anti-radiation and anti-interference capabilities. This ensures the sharing and transmission of the overall signals of the movable platform accurately and quickly.

The control method adopted by the control module 20 will be described in detail below.

In some exemplary embodiments, one of the control modules 20 is used for control. That is, one control module 20 of the at least two control modules 20 can issue a control instruction based on a signal(s) from the plurality of signal modules 10 to control a movable platform and/or the signal modules 10. In some exemplary embodiments, one of the control modules 20 is used for control. The control module 20 can issue a control instruction based on a signal(s) from the plurality of signal modules 10. The control instruction may control the movable platform, the signal module(s) 10, or both the movable platform and the signal module(s) 10.

With the above control method, when the control module 20 that performs control fails (including abnormal status, failure to work normally, etc.), other control modules 20 can replace the failed control module 20 to perform control. That is, when the control module 20 that issues control instructions fails, another control module 20 among the remaining control modules 20 may also issue control instructions based on signals from the plurality of signal modules 10 to control the movable platform and/or the signal modules 10.

In some exemplary embodiments, when the control module 20 that controls fails, another control module 20 may replace the failed control module 20 for control. This distributed control method can ensure the normal operation of the movable platform and improve the reliability of the movable platform.

During specific implementation, the control modules 20 can share their respective status information via the optical fiber bus, so other control modules 20 can obtain the status of the currently controlling control module 20 based on the shared status information, and determine whether the control module 20 is normal, whether there is a fault, etc. When it is determined that the current control module 20 fails, one of the other control modules 20 can replace the failed control module 20, and issue control instructions based on signals from the plurality of signal modules 10 to control the movable platform and/or the signal modules 10. Alternatively, when the control module 20 finds that it has a fault, it may send an alarm signal to other control modules 20 via the optical fiber bus 30. One of the other control modules 20 can replace the failed control module 20, and issue control instructions based on signals from the plurality of signal modules 10 to control the movable platform and/or the signal modules 10.

For example, the control modules include C1, C2, and C3. The current control module is C1. When C1 fails, C2 or C3 can be used for control.

In some exemplary embodiments, at least two control modules 20, taking turns in a cyclic manner, perform control. That is, the at least two control modules 20 can use a cyclic method to cause one of the control modules 20 to issue control instructions based on signals from the plurality of signal modules 10 to control the movable platform and/or the signal modules 10. For example, one control module 20 is not always used for control, but the plurality of control modules 20 can take turns to control.

The cycle time can be preset. That is, the at least two control modules 20 can cause one of the control modules 20 to issue control instructions based on signals from the plurality of signal modules 10 at a preset time interval(s) and in a cyclic manner to control the movable platform and/or the signal modules 10. In an example, the time interval(s) is preset. At each time interval, one of the control modules 20 is replaced for control. The preset time intervals can be the same or different.

For example, there are three control modules, namely C1, C2, and C3. It is set to replace one of the control modules for control every 2 hours during working hours. That is, C1 can work first, C2 will work 2 hours later, and then C3 will work 2 hours later, and so on. In another example, there are three control modules, C1, C2, and C3. The three control modules are replaced at intervals of 1 hour, 2 hours, and 3 hours for control, respectively. That is, C1 can work first, C2 will work after 1 hour, C3 will work after 2 hours, C1 will work after 3 hours, and so on.

Of course, if one of the control modules 20 fails, the failed control module 20 may be excluded, and the remaining control modules 20 can still control in a cyclic manner. That is, the remaining control modules 20 can have one of the remaining control modules 20 to issue control instructions based on the signals of the plurality of signal modules 10 at preset time intervals and in a cyclic manner to control the movable platform and/or the signal modules.

For example, there are three control modules, namely C1, C2, and C3. It is set to replace one of the control modules for control every 2 hours during working time. C1 can work first, C2 will work after 2 hours, and C3 will work after 2 hours, and so on. During the cycle, C1 fails, so C1 is excluded, and the remaining C2 and C3 can control in a cycle of every 2 hours of working time.

Details of the control module 20 will be further described below.

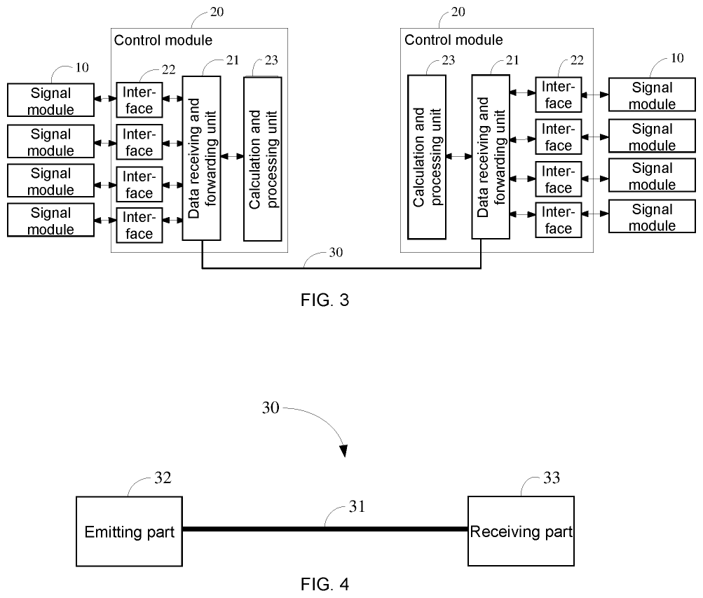

With reference to FIG. 3, in some exemplary embodiments, a special data receiving and forwarding unit 21 is provided in the control module 20 to receive the signals from the signal modules 10. That is, the control module 20 includes a data receiving and forwarding unit 21, and the data receiving and forwarding unit 21 is configured to receive signals from a group of the signal modules 10 in the area where it is located.

In some exemplary embodiments, the optical fiber bus 30 is provided between the data receiving and forwarding units 21. The data receiving and forwarding unit 21 is also configured to forward the received signals of a group of the signal modules 10 in the area to other data receiving and forwarding units 21.

In some exemplary embodiments, the optical fiber bus 30 is provided between the data receiving and forwarding units 21. The data receiving and forwarding unit 21 forwards a signal of the signal module 10 received by itself to other data receiving and forwarding units 21, thereby enabling efficient information sharing and information transmission.

In some exemplary embodiments, the control module 20 includes a plurality of interfaces 22, and the plurality of interfaces 22 are configured to connect to a group of the signal modules 10 in the area respectively. The data receiving and forwarding unit 21 receives signals from the group of the signal modules 10 in the area via the plurality of interfaces 22.

In some exemplary embodiments, the control module 20 is provided with a plurality of interfaces 22. The signal module 10 is connected to the control module 20 via the interface 22, which can facilitate the separate and flexible layout of the signal modules 10 and the control modules 20.

It should be noted that each interface 22 may match a corresponding signal module 10. For example, if the signal module is a camera sensor, the corresponding interface is a camera interface; if the signal module is a gimbal, the corresponding interface is a gimbal interface; if the signal module is radar, the corresponding interface is radar interface; and if the signal module is a perception sensor, the corresponding interface is a perception sensor interface; and so on.

In some exemplary embodiments, the control module 20 can further includes a calculation and processing unit 23. The calculation and processing unit 23 is connected to the data receiving and forwarding unit 21. The calculation and processing unit 23 is configured to process and calculate according to the signal from the signal module 10 sent by the data receiving and forwarding unit 21, and issue a control instruction to control the movable platform and/or the signal module(s) 10. The calculation and processing unit 23 and the data receiving and forwarding unit 21 may be connected by an on-chip bus.

In some exemplary embodiments, the control module 20 may separate the data receiving and forwarding unit 21 responsible for receiving signals from the calculation and processing unit 23 responsible for calculation and processing. It helps individual parts perform the respective duties thereof and improve work efficiency; it also facilitates determining the working status of the control module 20 and finding faults and problems.

In some exemplary embodiments, the control module 20 includes a head part control module and a tail part control module. The head part control module can be arranged in the head part of the movable platform; the tail part control module can be arranged in the tail part of the movable platform. The plurality of signal modules can be divided into two groups; one group of the signal modules is centrally distributed in the head part of the movable platform; the other group of the signal modules is centrally distributed in the tail part of the movable platform. In some exemplary embodiments, the plurality of signal modules can be divided into two groups; one group is concentrated in the head part of the movable platform, and the other group is concentrated in the tail part of the movable platform. The head part of the movable platform is equipped with a head part control module, and a tail part control module is provided in the tail part. Based on the above structure, the two groups of signal modules can be connected to the nearest head part control module and tail part control module, respectively.

Each of the head part control module and the tail part control module can obtain the signals of all signal modules on the movable platform via the optical fiber bus and control all signal modules on the movable platform.

The head part control module and the tail part control module can back up each other. Under normal circumstances, the head part control module can be used to control the movable platform and/or signal modules. When the head part control module fails, the tail part control module can take control to control the movable platform and/or signal modules. This distributed control method can improve the reliability of the mobile platform.

As shown in FIG. 4, in some exemplary embodiments, the optical fiber bus 30 includes an optical fiber 31, an emitting part 32 and a receiving part 33 respectively connected to both ends of the optical fiber 31.

The optical fiber bus is a high-speed optical fiber bus.

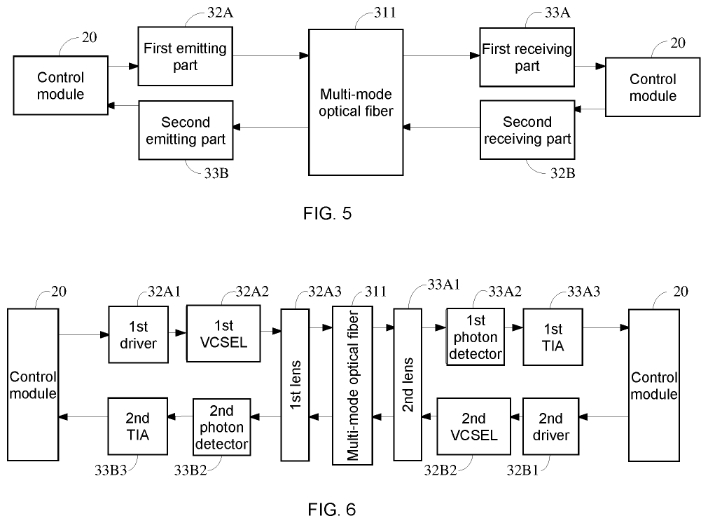

As shown in FIG. 5, in some exemplary embodiments, the optical fiber 31 is a multi-mode optical fiber 311. The emitting part 32 includes a first emitting part 32A and a second emitting part 32B. The receiving part 33 includes a first receiving part 33A and a second receiving part 33B. The two ends of the multi-mode optical fiber 311, in one direction, are respectively connected to the first emitting part 32A and the first receiving part 33A; in an opposite direction, the two ends of the multi-mode optical fiber 311 are respectively connected to the second emitting part 32B and the second receiving part 33B. The first emitting part 32A and the second receiving part 33B are connected with a control module 20. The second emitting part 32B and the first receiving part 33A are connected with another control module 20. In some exemplary embodiments, emitting and receiving are linked together by the multi-mode optical fiber, which is helpful for signal transmission and compact structure.

As shown in FIG. 6, the first emitting part 32A includes a first driver 32A1, a first vertical-cavity surface-emitting laser (VCSEL) 32A2 and a first lens 32A3 connected in sequence. The first receiving part 33A includes a second lens 33A1, a first photon detector 33A2 and a first trans-impedance amplifier 33A3 connected in sequence. The second emitting part 32B includes a second driver 3261, a second vertical-cavity surface-emitting laser (VCSEL) 32132 and a second lens 33A1 connected in sequence. The second receiving part 33B includes a first lens 32A3, a second photon detector 3362 and a second trans-impedance amplifier 3363 connected in sequence. The first driver 32A1 and the second trans-impedance amplifier 3363 are connected to a control module 20. The second driver 32B1 and the first trans-impedance amplifier 33A3 are connected to another control module 20. In this way, the light pathway is shared in the emitting direction and the receiving direction, which is helpful for signal transmission and simplification of the optical path structure.

Vertical-cavity surface-emitting laser (VCSEL) is a laser whose light emission direction is perpendicular to the surface of its resonant cavity. Compared with an edge-emitting laser, the vertical-cavity surface-emitting laser is easy to achieve two-dimensional planar and optoelectronic integration. Its circular beam is easy to achieve effective coupling with optical fiber and can achieve high-speed modulation. It can be applied to long-distance, high-speed optical fiber communication systems. Its active area size is extremely small, allowing high packaging density, low threshold current and low price. The drivers are used to amplify signals. Lenses are used to introduce the light generated by the laser into the optical fiber or to guide the light in the optical fiber out of the optical fiber. The photon detector (PD) is a radiation detector based on the external photoelectric effect or internal photoelectric effect. Electrons in the detector can directly absorb the energy of the photon, causing the state of motion to change to generate an electrical signal, which is used to detect photons. Trans-impedance amplifier (TIA) is a type of amplifier whose input is a current signal and whose output is a voltage signal.

In an emitting (transmitting) direction, the control module 20 (such as the data receiving and forwarding unit 21) sends a signal to the first driver 32A1, the first driver 32A1 enhances the signal and then drives the first vertical-cavity surface-emitting laser 32A2 to convert the electrical signal into an optical signal, and finally, the optical signal is emitted to the multi-mode optical fiber 311 via the first lens 32A3. In a receiving direction, an optical signal in the multi-mode optical fiber 311 passes through the second lens 33A1 and is then converted into an electrical signal by the first photon detector 33A2, the electrical signal is then amplified by the first trans-impedance amplifier 33A3 and sent to the control module 20 at the other end (for example, the data receiving and forwarding unit 21).

In an opposite emitting (transmitting) direction, the control module 20 (such as the data receiving and forwarding unit 21) sends a signal to the second driver 3261, the second driver 32B1 enhances the signal and drives the second vertical-cavity surface-emitting laser 3262 to convert the electrical signal into an optical signal, and finally, the optical signal is emitted to the multi-mode optical fiber 311 via the second lens 33A1. In a receiving direction, an optical signal in the multi-mode optical fiber 311 passes through the first lens 32A3 and is then converted into an electrical signal by the second photon detector 3362, and the electrical signal is then amplified by the second trans-impedance amplifier 3363 and sent to the control module 20 at the opposite end (for example, the data receiving and forwarding unit 21).

The present disclosure further provides a movable platform. The movable platform includes a distributed structure as described in any of the above exemplary embodiments. In addition, the movable platform may further include a platform body as a major part of the movable platform, and the platform body includes at least the head part and the tail part mentioned above. In addition, the movable platform also includes a driving part, which may include at least one motor and at least one propeller in the case of a UAV, and the motor may further needs a power source to provide power. For detailed descriptions of related contents, reference can be made to the distributed structure described above, and will not be repeated herein.

It should be understood that the terminology used herein is for the purpose of describing particular exemplary embodiments only and is not intended to limit the present disclosure.

It should also be understood that the term “and/or” as used herein refers to and includes any and all possible combinations of one or more of the listed associated items.

The above are only some specific exemplary embodiments of the present disclosure; the scope of protection of the present disclosure is not limited thereto. A person skilled in the art can easily think of various equivalent modifications or substitutions within the technical scope disclosed herein. These modifications or substitutions should be covered by the scope of protection of the present disclosure. Therefore, the scope of protection of the present disclosure should be determined by the scope of protection defined by the appended claims.

What is claimed is:

1. A movable platform, comprising:
a platform body;
a driving part to drive the movable platform to move;
a plurality of signal modules, divided into at least two groups, with each group of signal modules concentrated in an area;
at least two control modules, with each control module arranged in a corresponding area where a corresponding group of signal modules is located, wherein each control module is configured to obtain corresponding signals from the corresponding group of signal modules in the corresponding area respectively; and
a signal transmission device, arranged between the at least two control modules and configured to transmit signals between the at least two control modules.

2. The movable platform according to claim 1, wherein one of the at least two control modules is configured to issue a control instruction based on the corresponding signals from the plurality of signal modules to control at least one of the movable platform, or the plurality of signal modules.

3. The movable platform according to claim 2, wherein when the control module configured to issue the control instruction fails, another control module is enable to issue the control instruction based on the corresponding signals from the plurality of signal modules to control at least one of the movable platform, or the plurality of signal modules.

4. The movable platform according to claim 1, wherein the at least two control modules are configured to issue, taking turns in a cyclic manner, a control instruction based on the corresponding signals from the plurality of signal modules to control at least one of the movable platform, or the plurality of signal modules.

5. The movable platform according to claim 4, wherein the at least two control modules are configured to issue, taking turns in the cyclic manner and based on preset time intervals, the control instruction based on the corresponding signals from the plurality of signal modules to control at least one of the movable platform, or the plurality of signal modules.

6. The movable platform according to claim 1, wherein each control module is configured to indirectly obtain corresponding signals of another group of signal modules in another area of another control module via the signal transmission device.

7. The movable platform according to claim 1, wherein the control module each includes a data receiving and forwarding unit configured to receive the corresponding signals from the corresponding group of signal modules in the corresponding area.

8. The movable platform according to claim 7, wherein the signal transmission device is arranged between the data receiving and forwarding units, and the data receiving and forwarding unit is further configured to forward a received signal from the corresponding group of signal modules in the corresponding area to another data receiving and forwarding unit.

9. The movable platform according to claim 7, wherein the control module each includes a plurality of interfaces configured to respectively connected to the corresponding group of signal modules in the corresponding area, and the data receiving and forwarding units receives corresponding signals from the corresponding group of signal modules in the corresponding area via the plurality of interfaces.

10. The movable platform according to claim 7, wherein the control module each further includes a calculation and processing unit connected to the data receiving and forwarding unit, the calculation and processing unit is configured to calculate and process the corresponding signals from the corresponding group of signal modules sent by the data receiving and forwarding unit, and to issue a control instruction to control at least one of the movable platform, or the plurality of signal modules.

11. The movable platform according to claim 1, wherein the platform body includes a head part and a tail part, the control module includes a head part control module arranged in the head part and a tail part control module arranged in the tail part, the plurality of signal modules are divided into two sets, with one set of signal modules concentrated in the head part and the other set of signal modules concentrated in the tail part.

12. The movable platform according to claim 1, wherein the signal module includes at least one of a sensor or a load.

13. The movable platform according to claim 1, wherein the signal module includes at least two of a sensing sensor, a camera sensor, a gimbal, a radar, a global positioning system (GPS) sensor, a time-of-flight sensor, an inertial sensor, a compass, or an electronic speed control.

14. The movable platform according to claim 1, wherein the movable platform includes an unmanned aerial vehicle.

15. The movable platform according to claim 1, wherein each of the at least two control modules is arranged close by the corresponding group of signal modules thereof.

16. The movable platform according to claim 1, wherein the at least two groups of signal modules are arranged apart from one another.

17. The movable platform according to claim 1, wherein the signal transmission device includes an optical fiber, and an emitting part and a receiving part respectively connected to two ends of the optical fiber.

18. The movable platform according to claim 16, wherein the optical fiber is a multimode optical fiber, the emitting part includes a first emitting part and a second emitting part, the receiving part includes a first receiving part and a second receiving part, two ends of the multi-mode optical fiber in one direction are respectively connected to the first emitting part and the first receiving part, the two ends of the multi-mode optical fiber in an opposite direction are respectively connected to the second emitting part and the second receiving part, the first emitting part and the second receiving part are connected to a control module of the at least two control modules, and the second emitting part and the first receiving part are connected to another control module of the at least two control modules.

19. The movable platform according to claim 17, wherein the first emitting part includes a first driver, a first vertical-cavity surface-emitting laser and a first lens connected in sequence, the first receiving part includes a second lens, a first photon detector and a first trans-impedance amplifier connected in sequence, the second emitting part includes a second driver, a second vertical-cavity surface-emitting laser and the second lens connected in sequence, the second receiving part includes the first lens, a second photon detector and a second trans-impedance amplifier connected in sequence, the first driver and the second trans-impedance amplifier are connected to a control module of the at least two control modules, and the second driver and the first trans-impedance amplifier are connected to another control module of the at least two control modules.

20. A control method for a movable platform, comprising:
issuing, by at least two control modules taking turns in a cyclic manner, a control instruction based on signals from a plurality of signal module at predetermined time intervals, wherein each control module is configured to obtain the signals from the plurality of signal modules;
transmitting signals between the at least two control modules via a signal transmission device; and
controlling, based on the control instruction, at least one of the movable platform, or the plurality of signal modules.
